(19) United States
(12) Patent Application Publication
(10) Pub. No.: US 2025/0145045 A1
(43) Pub. Date: May 8, 2025

(54) SERVER DEVICE

(71) Applicant: SUBARU CORPORATION, Tokyo (JP)

(72) Inventors: Tomoyuki KITAMURA, Tokyo (JP); Yusuke OTSUKA, Tokyo (JP); Keita NAKAHASHI, Tokyo (JP)

(21) Appl. No.: 19/015,472

(22) Filed: Jan. 9, 2025

Related U.S. Application Data
(63) Continuation of application No. PCT/JP2023/024365, filed on Jun. 30, 2023.

(51) Int. Cl. B60L 53/66; G06Q 10/02

(52) U.S. Cl. CPC B60L 53/665; G06Q 10/02

(57) ABSTRACT

A server device includes one or more processors, and a storage medium storing a program. The program includes one or more instructions. The one or more instructions cause the one or more processors to execute: a registration process to register information related to one or more providers who provide a charger installed for self-use and information related to one or more user who are to use a charger installed for use by others; a reservation setting process to, in response to a use request from a user terminal, extract a provider matching the use request from registration information, cause the user terminal to present information related to the extracted provider and an area displayed on a map image in such a manner that a home of the provider is not identifiable, and set a reservation; and a payment process to make a payment in accordance with the set reservation.

### CROSS-REFERENCE TO RELATED APPLICATIONS

This application is continuation of International Application No. PCT/JP2023/024365, filed on Jun. 30, 2023, the entire contents of which are hereby incorporated by reference.

### BACKGROUND

The disclosure relates to a server device, and relates to a technique for providing a charging spot to a user of an electric vehicle or the like.

WO2011/115113 and Japanese Unexamined Patent Application Publication No. 2019-221014 disclose techniques for charging an electric vehicle by using a charging station for home use.

### SUMMARY

An aspect of the disclosure provides a server device including one or more processors and a storage medium. The storage medium stores a program to be executed by the one or more processors. The program includes one or more instructions. The one or more instructions cause the one or more processors to execute: a registration process to register information related to one or more providers who provide a charger installed in a parking lot for self-use and information related to one or more users who are to use a charger installed in a parking lot for use by another person; a reservation setting process to, in response to a use request transmitted from a user terminal, extract a provider who matches the use request from registration information, cause the user terminal to present information related to the extracted provider and an area displayed on a map image in such a manner that a home of the provider is not identifiable from the displayed area, and set a reservation in accordance with information from the user terminal; a payment process to make a payment for using a charger provided from the provider to charge a vehicle by a user who uses the user terminal in accordance with the set reservation.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a diagram illustrating a configuration of a system according to an embodiment of the disclosure;

FIG. 2 is a block diagram of an information processing device such as a server device according to the embodiment;

FIG. 3 is a block diagram illustrating a configuration of a vehicle according to the embodiment;

FIG. 4 is a diagram illustrating a procedure of a charger rental service according to the embodiment;

FIG. 5 is a diagram illustrating a functional configuration of the server device according to the embodiment;

FIG. 6 is a diagram illustrating of a functional configuration of a user terminal according to the embodiment;

FIG. 7 is a diagram illustrating of a functional configuration of a provider terminal according to the embodiment;

FIG. 8 is a flowchart of a registration process according to the embodiment;

FIG. 9 is a flowchart of a reservation process according to the embodiment;

FIG. 10 is a diagram illustrating a display example at the time of reservation according to the embodiment;

FIG. 11 is a diagram illustrating a display example at the time of reservation according to the embodiment; and

FIG. 12 is a flowchart of a process after the execution of charging according to the embodiment.

### DETAILED DESCRIPTION

In recent years, electric vehicles have become increasingly widespread. However, when a battery of an electric vehicle has low remaining charge in a location away from home, there may be no facility (charging spot) for charging the battery. For example, a mountainous area away from an urban area is expected to have a small number of stores as charging stations.

In a household having a charging spot (charger) at home, the charger is not used while the people of the household go out by vehicle, and the utilization rate of the charger decreases. In a case where a charger installed at home is allowed to be used by a person other than the owner of the home, the home's parking lot is occupied by the person. If the owner comes back to the home before the person completes the charging, the owner may not be able to park in the parking lot. For the reasons described above, when a personal residence is used as a charging spot, it is difficult to adjust the use of the charging spot.

It is desirable to provide a technique for effectively using a charger at a personal residence and facilitating adjustment of the use of the charger.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

### System Configuration

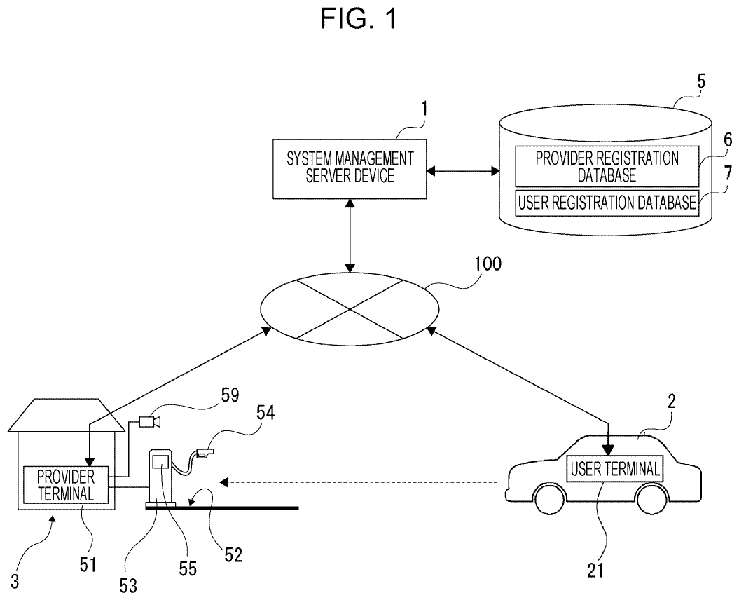

FIG. 1 illustrates a configuration of a system for a charger rental service according to the embodiment. The system is a system in which adjustment can be made between a provider of a charger and a user who desires to rent the charger. The system is configured such that a system management server device 1 (hereinafter referred to as a “server device 1”), a user terminal 21, and a provider terminal 51 communicate with each other via a network 100.

The user is a person who is registered as a user in a charger rental service provided by the server device 1. A person who desires to use the charger rental service is registered as a user, thereby being able to use a charger 53 of another person for a fee, for example.

The provider is a person who allows another person to rent the charger 53, which is installed in a parking lot 52 used by the provider, and who is registered as a provider in the charger rental service provided by the server device 1. A person who becomes a registered provider can receive a reward in compensation for allowing another person to use the charger 53.

The user terminal 21 is an information processing device used by the user, and is a terminal device capable of communicating with at least the server device 1 via the network 100. For example, an information processing device in the vehicle 2 may be used as the user terminal 21, or an information processing device such as a smartphone, a personal computer, or a tablet device carried by the user may be used as the user terminal 21.

The user who uses the user terminal 21 can use the user terminal 21 to enjoy the service provided by the present system by, for example, browsing a web site provided by the server device 1 or activating an application program.

The provider terminal 51 is an information processing device used by the provider, and is a terminal device capable of communicating with at least the server device 1 via the network 100. For example, the provider terminal 51 may be a personal computer or the like in a residence 3 or the like of the provider, or may be an information processing device built in the charger 53. Further, the provider terminal 51 may be a smartphone, a tablet device, or the like carried by the provider. Further, an information processing device in a vehicle (not illustrated) used by the provider may be the provider terminal 51.

An information processing device built in the residence 3 or the charger 53 and a smartphone, a tablet device, or the like carried by the provider may be synchronized and used as the provider terminal 51.

Further, a smartphone, a tablet device, or the like carried by the provider may be used as a user interface device, for the provider, of the provider terminal 51 built in the residence 3 or the charger 53.

The provider terminal 51 performs, for example, a process of transmitting provision information to the server device 1 in accordance with the convenience of the provider, and a process of transmitting information regarding rental of the charger 53 to the server device 1. Accordingly, the provider terminal 51 is any information processing device capable of performing the processes described above, and is not limited to a specific form. Further, for example, a smartphone and an information processing device in the charger 53 may serve as the provider terminal 51 in cooperation with each other.

The server device 1 is a server device of a company or the like that operates the charger rental service, and includes one or more information processing devices. The server device 1 can access a storage device 5. The storage device 5 includes a provider registration database 6 for registering providers and a user registration database 7 for registering users.

The server device 1 communicates with the user terminal 21 and the provider terminal 51 to coordinate between the user and the provider, and provides a service of performing matching so that charging is performed at a place and date and time desired by the user. As a result, the user can charge the vehicle 2 even in an area where charging stations and the like are not available. The provider is given a reward for charger rental. Thus, a simple business opportunity is provided to the provider.

The charger 53 is installed in the parking lot 52 in the residence 3 of the provider. Normally, the vehicle of the provider is parked in the parking lot 52, and is charged using the charger 53. In the charger rental service according to the present embodiment, when the provider goes out by vehicle and the parking lot 52 and the charger 53 are not in use, the user is allowed to perform charging.

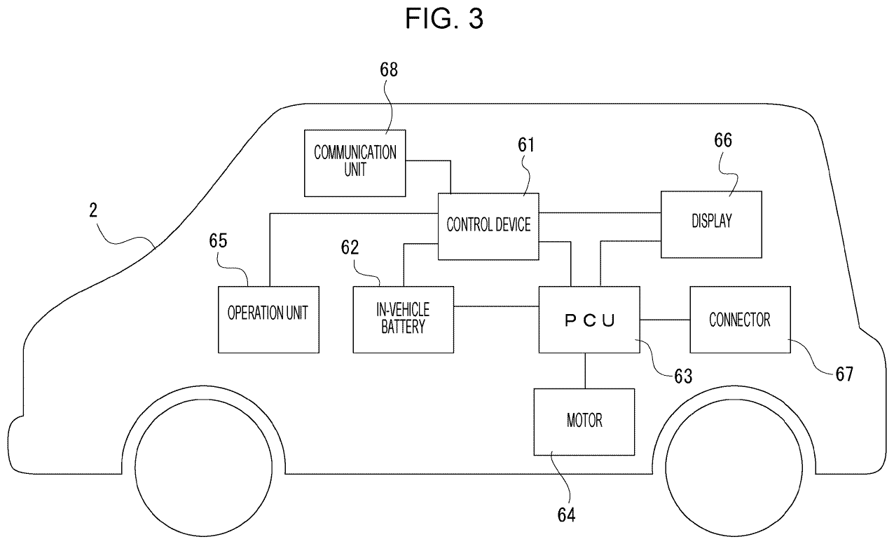

The charger 53 is provided with a panel 55 as a display or an operation panel. For example, the panel 55 can guide the user to operate or use the charger 53 at the time of charging. The user couples a gun 54 to a connector 67 (see FIG. 3), which is a charging port of the vehicle 2, and performs charging.

The charger 53 is internally provided with a measurement circuit for measuring the amount of charge, and the measurement circuit measures the amount of charge during charging. The provider terminal 51 can acquire information on the amount of charge measured by the measurement circuit. In the illustrated example, a camera 59 is installed in the parking lot 52, by way of example. The camera 59 enables, for example, imaging of a license plate, a vehicle body, a charging state, or the like of the vehicle 2 of the user. The provider terminal 51 can acquire information on the vehicle 2, such as a vehicle number and a vehicle type, for example, from the video captured by the camera 59. Alternatively, the provider terminal 51 may transmit the video data to the server device 1, and the server device 1 may detect the vehicle number, the vehicle type, and the like.

FIG. 1 illustrates the charger 53 installed in the parking lot 52 in the residence 3, and the residence 3 may be any type of house such as a detached house or a multiple dwelling house. In addition, the parking lot 52 may be a place separate from the residence 3, and may be a parking lot where the provider usually parks.

In the present embodiment, the charger 53, which is a target of the charger rental service, is a charger installed in the parking lot 52 used by the provider, for example, a parking lot in the premises of the residence 3 as a home, or a parking lot that is away from the home but is owned or rented by the provider.

The charger 53 is a charger owned or rented by the provider as a charger usually used by the provider or their family.

However, the above is an example of a case where the provider is an individual. The provider according to the present embodiment may be a company, an organization, or the like, and a parking lot or a charger of the company or the like may be the parking lot 52 or the charger 53 in FIG. 1.

### Configuration of Information Processing Device

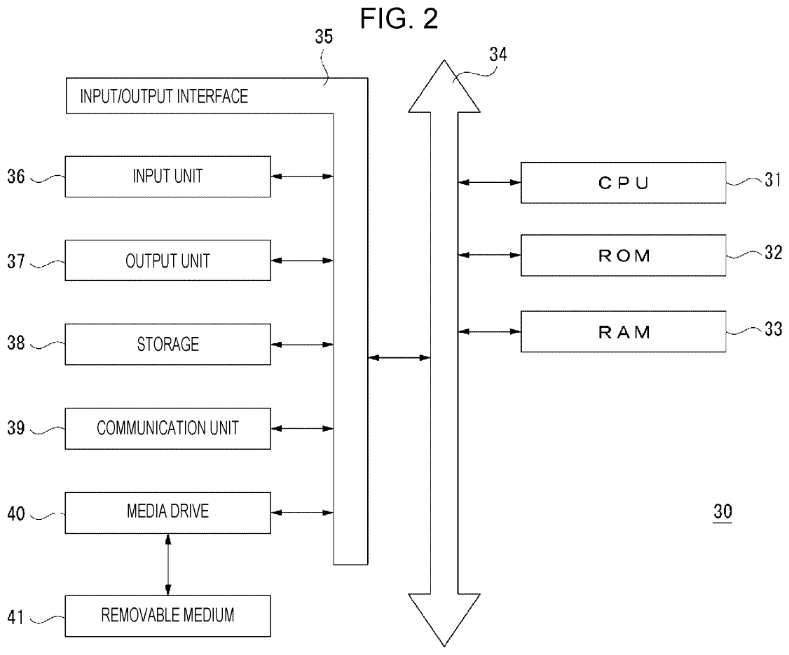

FIG. 2 illustrates an example configuration of an information processing device 30 that can be used as the server device 1, the user terminal 21, or the provider terminal 51.

The information processing device 30 includes a central processing unit (CPU) 31, a read only memory (ROM) 32, a random access memory (RAM) 33, a bus 34, an input/output interface 35, an input unit 36, an output unit 37, a storage 38, a communication unit 39, a media drive 40, and the like.

The CPU 31 executes various processes in accordance with a program stored in the ROM 32 or a program loaded from the storage 38 to the RAM 33. The RAM 33 also stores information to be used for the CPU 31 to execute various processes.

The CPU 31, the ROM 32, and the RAM 33 are coupled to each other via the bus 34. The input/output interface 35 is also coupled to the bus 34.

The input unit 36, the output unit 37, the storage 38, the communication unit 39, and the media drive 40 are coupled to the input/output interface 35.

The input unit 36 includes a keyboard, a mouse, a touch panel, a microphone, and the like.

The output unit 37 includes a display such as a liquid crystal display (LCD) or an organic electroluminescent (EL) panel, a speaker, and the like.

The storage 38 includes a hard disk drive (HDD), a flash memory device, and the like. When the information processing device 30 having the configuration described above is applied as the server device 1, the storage 38 may form a database that stores registration information and the like.

The communication unit 39 performs communication processing and inter-device communication via a communication network.

For example, a removable medium 41, such as a semiconductor memory card, is placed on the media drive 40, and information is written to or read from the removable medium 41.

In the information processing device 30, data or a program is uploaded or downloaded through communication by the communication unit 39. Further, data and programs can be transferred via the removable medium 41.

The CPU 31 performs processing operations based on various programs to execute information processing and communication necessary for the server device 1, the user terminal 21, or the provider terminal 51.

### Vehicle Configuration

A system in a vehicle may be used as the user terminal 21 or the provider terminal 51. FIG. 3 illustrates a configuration of the vehicle 2 related to charging and an example configuration serving as the user terminal 21 or the provider terminal 51.

The vehicle 2 includes a control device 61, an in-vehicle battery 62, a power control unit (PCU) 63, a motor 64, an operation unit 65, a display 66, the connector 67, and a communication unit 68.

Some of the components of the vehicle 2 are illustrated in FIG. 3, and the vehicle 2 includes a map locator, various sensors for driving the vehicle 2, a communication device, and so on, which are not illustrated in FIG. 3.

The control device 61 includes a CPU, a memory, and the like, and performs overall control of the vehicle 2. The control device 61 may be configured as a single unit or may include electronic control units (ECUs). The ECUs may include various ECUs. Examples of such ECUs include a battery control ECU for performing charging control of the in-vehicle battery 62, a display control ECU for performing display control of a display device (also including a meter or the like) included in the vehicle 2, an airbag control ECU, and an air-conditioning control ECU.

In the present embodiment, furthermore, it is assumed that the vehicle 2 is an automobile that travels by automatic driving. For this reason, the vehicle 2 is also equipped with an information processing device to be used for automatic driving. For example, the control device 61 may also include an automatic driving ECU for performing control according to a traveling route determination or an external environment, a traveling control ECU for performing control to travel or stop traveling by using a motor in accordance with an instruction from the automatic driving ECU, a steering control ECU for performing steering control in accordance with an instruction from the automatic driving ECU, and the like.

Although not illustrated, the vehicle 2 is also equipped with devices for sensing the surroundings, such as a camera and a sensor, and devices for detection to obtain map information, road information, current position information, and the like, for automatic driving control.

The control device 61 executes various programs stored in the memory or the like to implement various functions.

Accordingly, the control device 61 can have a configuration equivalent to the configuration illustrated in FIG. 2.

The in-vehicle battery 62 is a high-voltage battery used for traveling of the vehicle 2. The in-vehicle battery 62 supplies electric power to be used for driving wheels of the vehicle 2, electric power to be used for operating an air conditioner of the vehicle 2, and electric power to be used for operating other devices of the vehicle 2. In FIG. 3, the supply of electric power to be used for driving the wheels from the in-vehicle battery 62 and the supply of electric power from the in-vehicle battery 62 to the display 66 are illustrated, but the supply of electric power to be used for the operations of the other components is not illustrated.

The in-vehicle battery 62 is charged by a current supplied from the PCU 63.

The in-vehicle battery 62 supplies a power supply voltage to the PCU 63 to drive the motor 64.

The PCU 63 includes an inverter, a DC-DC converter, and so on to drive the motor 64.

The PCU 63 generates, based on the supplied power supply voltage, an alternating-current (AC) current for driving the motor 64 and supplies the AC current to the motor 64. The PCU 63 controls the AC current to perform torque control of the motor 64. The PCU 63 may further have a regenerative braking function to optimize energy efficiency using regenerative energy.

The motor 64 is configured as a motor generator having an electric power generation function. The motor 64 drives the wheels based on the supplied AC current.

The operation unit 65 includes, for example, operating elements such as various buttons and levers arranged in front of a driver's seat of the vehicle 2. The operation unit 65 may also include a multi-function display (MFD) having a touch panel function, a display of a navigation device, and so on.

The display 66 comprehensively represents, for example, an MFD installed in front of the driver and other display devices for presenting information to the driver. The display 66 performs display based on detection signals detected by the various sensors included in the vehicle 2. The display 66 appropriately displays various kinds of information such as a total travel distance of the vehicle 2, an outside air temperature, and instantaneous fuel efficiency. The display 66 can also display map information, extracted route information, and so on.

The display 66 may be configured to display a screen of the charger rental service according to the present embodiment.

The connector 67 has a structure such that a charging plug (the gun 54) included in a charging facility such as the charger 53 can be inserted into the connector 67. The connector 67 outputs an AC voltage supplied through the inserted charging plug to the PCU 63. The PCU 63 includes an AC-DC converter and supplies a direct-current (DC) voltage, which is obtained by conversion, to the in-vehicle battery 62 to charge the in-vehicle battery 62.

The communication unit 68 includes a wireless communication device, and performs communication with the server device 1 or the like via the network 100, for example.

### Overview of Charger Rental Service

An overview of the charger rental service provided by the server device 1 will be described.

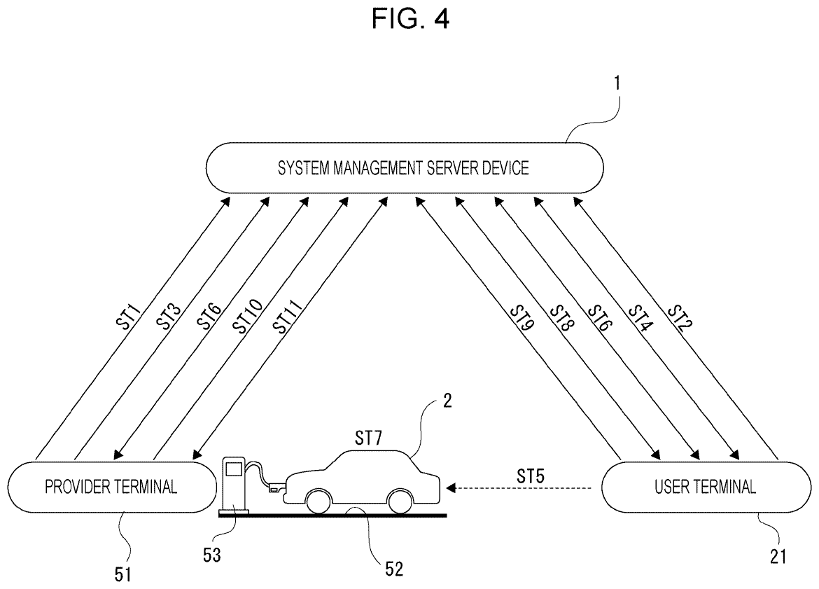

The service, including the actions of the user and the provider, is implemented by a procedure from ST1 to ST11 illustrated in FIG. 4.
(ST1) A customer who desires to be the provider uses the provider terminal 51 to register the charger 53, which is rentable, in the server device 1. In one example, personal information of the provider, information for payment, position information of the parking lot 52, and information such as a model and specifications of the charger 53 are registered.
(ST2) A customer who desires to be the user uses the user terminal 21 to register user information (such as vehicle information and personal information) in the server device 1.
(ST3) The provider uses the provider terminal 51 to transmit provision information including date and time information indicating a date and time when the charger 53 can be rented, to the server device 1 at any time point. The provision information is information for informing the server device 1 that the provider can provide the parking lot 52 to another person for a time period from a certain date and time to a certain date and time.
(ST4) The user uses the user terminal 21 to transmit a use request to the server device 1 at any time point to use the charger 53. The use request includes information such as an area and a date and time where and when the user desires to use the charger 53. In response to the request from the user, the server device 1 selects a provider that matches the request in terms of the area and the date and time among providers from which provision information has been received, and provides the user with information on a list of rentable chargers 53. The user selects a charger 53 that the user desires to use from among the rentable chargers 53, and performs a decision operation for deciding to make a reservation to the server device 1. The server device 1 performs reservation setting in response to the decision operation.
(ST5) The vehicle 2 of the user moves to the parking lot 52 in which the charger 53 is installed on the reserved date and time.
(ST6) When using the charger 53, the user is authenticated by one or both of the user terminal 21 and the provider terminal 51. The authentication result is also shared by the server device 1.
(ST7) The user performs charging. At this time, the provider terminal 51 is used to also measure the amount of charge.
(ST8) After the charging is completed, a process for paying the fee is performed between the user terminal 21 and the server device 1.
(ST9) The user transmits evaluation information of the provider by using the user terminal 21 (or a device such as a smartphone serving as a user interface device of the user terminal 21).
(ST10) The provider transmits the evaluation of the user to the server device 1 by using the provider terminal 51.
(ST11) The server device 1 gives a reward to the provider.

The order of (ST8), (ST9), (ST10), and (ST11) may be different from that described above. The processes of (ST1), (ST2), (ST3), and (ST4) are sequentially performed between an unspecified number of customers and the server device 1.

A functional configuration of the server device 1 for executing the charger rental service as described above will be described. For example, the server device 1 having the configuration of the information processing device 30 illustrated in FIG. 2 implements various functions when the CPU 31 executes a program.

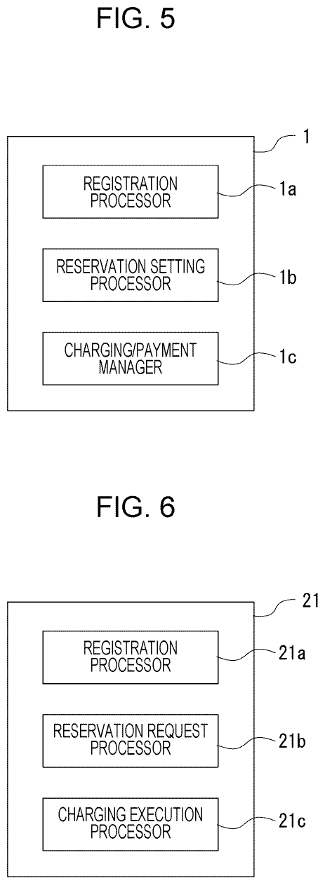

FIG. 5 illustrates an example of functions provided in the CPU 31 for the charger rental service according to the present embodiment.

A registration processor 1a is a function of performing processing related to registration of the user and the provider. The server device 1 provides the charger rental service to a customer registered as the user. The server device 1 further provides the user with information on the charger 53 of a customer who satisfies the condition among the customers registered as providers.

A reservation setting processor 1b is a function of performing processing for setting a reservation for charger rental between the user and the provider. Accordingly, the reservation setting processor 1b performs processing related to provision information from the provider. The provision information includes date and time information indicating a date and time when the provider can provide the charger 53 and the parking lot 52 to another person. For example, the date and time information is information including an available rental start date and time and an available rental end date and time. The reservation setting processor 1b also performs processing for receiving a reservation request from the user and introducing a provider who satisfies the condition to the user.

A charging/payment manager 1c is a function of performing management processing such as management related to the use of the charger 53 by the user, the payment made by the user, and the provision of a reward to the provider.

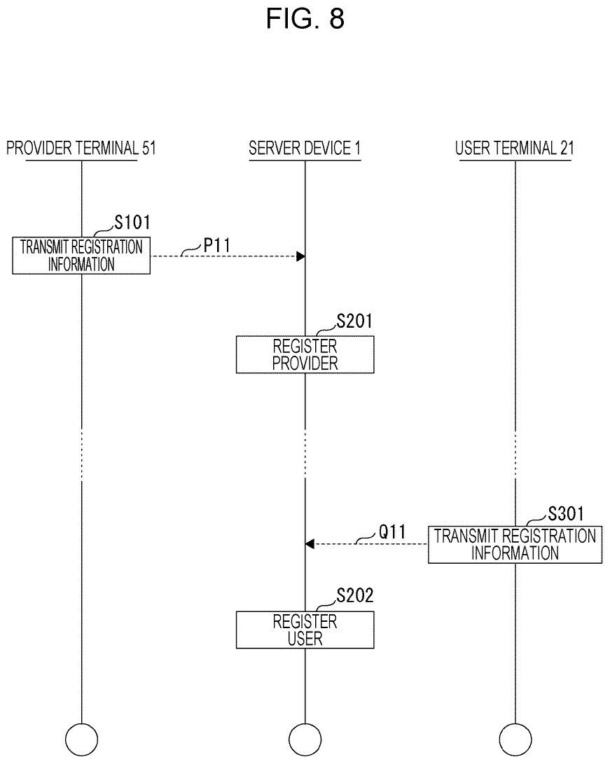

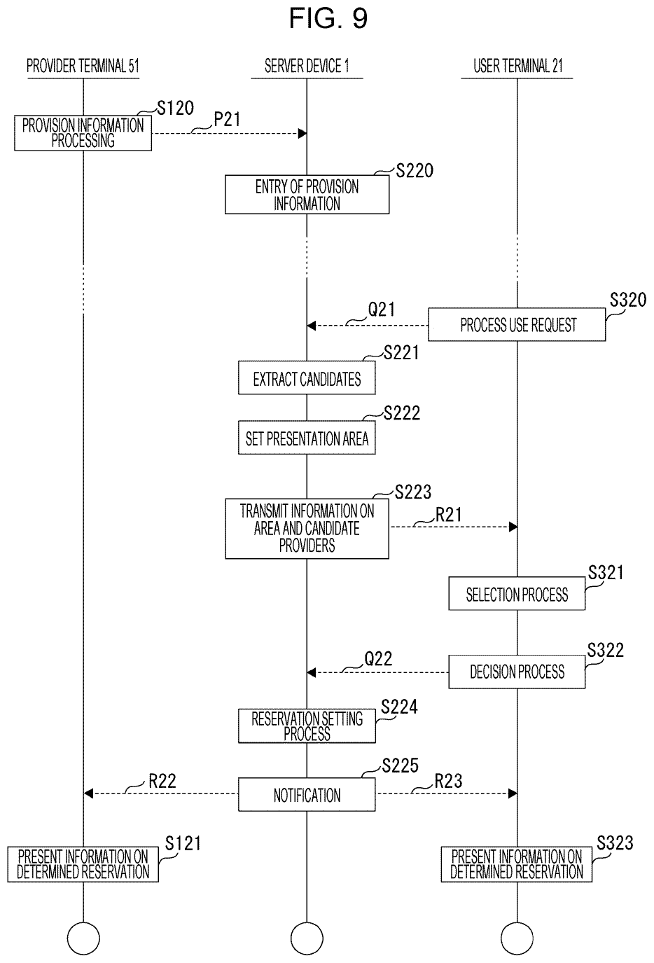

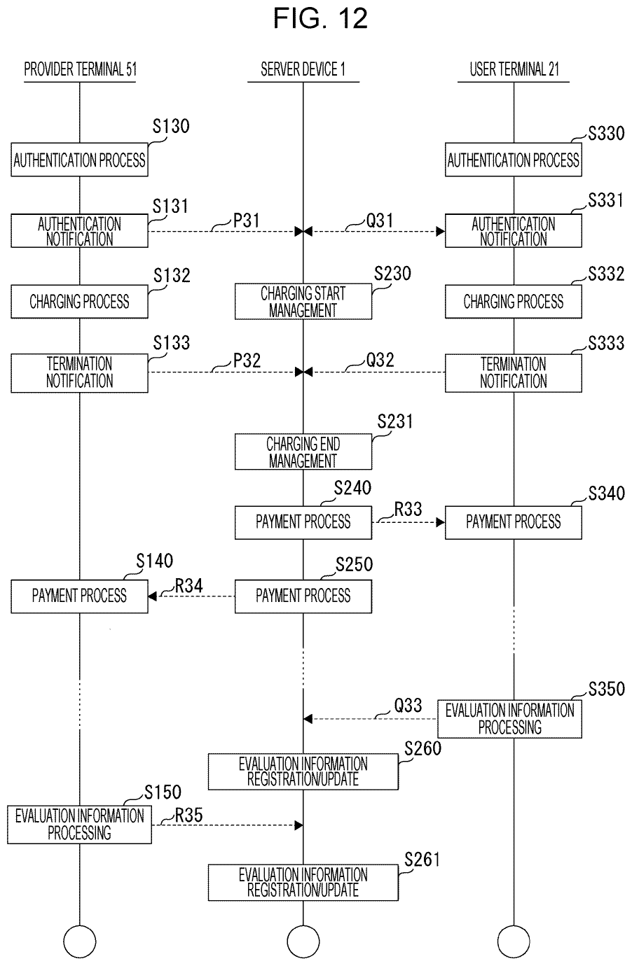

The server device 1 performs processes illustrated in FIG. 8, FIG. 9, and FIG. 12, which will be described below, by using the functions of the registration processor 1a, the reservation setting processor 1b, and the charging/payment manager 1c.

Next, a functional configuration of the user terminal 21 will be described. For example, the user terminal 21 having the configuration of the information processing device 30 illustrated in FIG. 2 or the user terminal 21 implemented as the control device 61 illustrated in FIG. 3 implements various functions when the CPU 31 executes a program. FIG. 6 illustrates an example of functions provided in the CPU 31 of the user terminal 21 for the charger rental service according to the present embodiment.

A registration processor 21a is a user interface for the user to perform user registration and a function of performing processing such as transmission of registration information to the server device 1.

A reservation request processor 21b is a user interface for the user to make a use request and a function of communicating with the server device 1.

A charging execution processor 21c is a function of performing processing for the user to perform charging using the charger 53, for example, authentication processing and communication with the server device 1.

The user terminal 21 performs the processes illustrated in FIG. 8, FIG. 9, and FIG. 12, which will be described below, by using the functions of the registration processor 21a, the reservation request processor 21b, and the charging execution processor 21c.

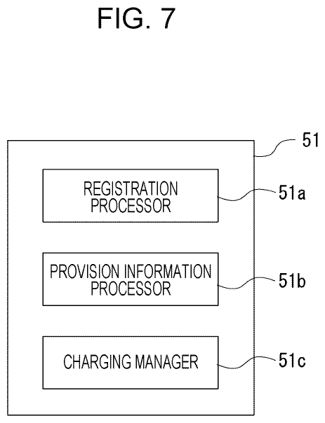

Next, a functional configuration of the provider terminal 51 will be described. For example, the provider terminal 51 having the configuration of the information processing device 30 illustrated in FIG. 2 or the provider terminal 51 implemented as the control device 61 illustrated in FIG. 3 implements various functions when the CPU 31 executes a program. FIG. 7 illustrates an example of functions provided in the CPU 31 of the provider terminal 51 for the charger rental service according to the present embodiment.

A registration processor 51a is an interface for the provider to perform provider registration and a function of performing processing such as transmission of registration information to the server device 1.

A provision information processor 51b is a user interface or a communication function for transmitting, to the server device 1, provision information indicating a date and time when the provider can rent the charger 53.

A charging manager 51c is a function of performing processing for the user to perform charging using the charger 53, for example, authentication processing and processing related to measurement of the amount of charge and the amount of electric power and payment, and operations involved in such processing, such as communication with the server device 1.

The provider terminal 51 performs the processes illustrated in FIG. 8, FIG. 9, and FIG. 12, which will be described below, by using the functions of the registration processor 51a, the provision information processor 51b, and the charging manager 51c.

Hereinafter, an example of processes performed by the server device 1, the user terminal 21, and the provider terminal 51 having the functions described above will be described.

FIG. 8 illustrates an example of processing related to registration performed in advance in (ST1) and (ST2) described above. This processing is performed by the functions of the registration processor 1a of the server device 1, the registration processor 21a of the user terminal 21, and the registration processor 51a of the provider terminal 51.

In step S101, the provider terminal 51 transmits registration information P11 to the server device 1.

For example, a customer who desires to be the provider operates the provider terminal 51 to input necessary registration information and perform a transmission operation. In response to this, the provider terminal 51 transmits the registration information P11.

The registration information P11 of the provider includes, for example, personal information such as a name, an address, an e-mail address, and an account for receiving a reward, information related to the parking lot 52, and information related to the charger 53.

Examples of the information related to the parking lot 52 may include the size of the parking lot 52, an access route to the parking lot 52, an image of the parking lot 52, the type of the parking lot 52, information as to whether the parking lot 52 is paved, and information as to whether the parking lot 52 is roofed.

Examples of the information related to the charger 53 may include a type, a product name, a model number, charging capacity, and various specifications of the charger 53, a type and a length of the gun 54, and an image of the charger 53.

When the server device 1 receives the registration information P11 including some or all of the contents described above, in step S201, the server device 1 performs a registration process on the provider registration database 6 in the storage device 5. Thus, the customer who has performed the registration operation is registered as the provider of the charger rental service.

Not all of the items of the registration information P11 may be entered by the provider. For example, when the provider enters some of the items of the information related to a charger, such as the product name and the model number of the charger, the server device 1 may determine the specifications of the charger and add the specifications to the registration information P11 to perform registration.

In step S301, the user terminal 21 transmits registration information Q11 to the server device 1.

For example, a customer who desires to be the user operates the user terminal 21 to input necessary registration information and perform a transmission operation. In response to this, the user terminal 21 transmits the registration information Q11.

The registration information Q11 of the user includes, for example, personal information such as a name, an address, an e-mail address, and a credit card number for payment, and vehicle-related information.

Examples of the vehicle-related information may include a vehicle type, a model year, a vehicle number, and a color of the vehicle.

The registration information Q11 may include a type, a product name, a model number, and the like of a charger to which the vehicle can be coupled. Alternatively, the server device 1 may determine a charger to which the vehicle can be coupled, from the vehicle type information.

When the server device 1 receives the registration information Q11 including some or all of the contents described above, in step S202, the server device 1 performs a registration process on the user registration database 7 in the storage device 5. Thus, the customer who has performed the registration operation is registered as the user.

As described above, the provider registration database 6 and the user registration database 7 are sequentially updated. The providers in the provider registration database 6 and the users in the user registration database 7 mutually input evaluation information at the time of rental. The input evaluation information is also sequentially added to and updated in the provider registration database 6 and the user registration database 7 by the server device 1.

Next, processing related to (ST3) and (ST4) described above, that is, processing up to a reservation of use, will be described with reference to FIG. 9. This processing is performed by the functions of the reservation setting processor 1b of the server device 1, the reservation request processor 21b of the user terminal 21, and the provision information processor 51b of the provider terminal 51.

In step S120, provision information P21 is transmitted from the provider terminal 51 to the server device 1. For example, at any time point such as when a schedule of going out is determined or when the provider goes out, the provider inputs the provision information to the provider terminal 51 and performs a transmission operation. As a result, the provision information P21 is transmitted to the server device 1.

The provision information P21 includes date and time information indicating a date and time when the provider can provide the charger 53 and the parking lot 52 to another person, and provider identification information. The date and time information is information for identifying at least an available rental start date and time and an available rental end date and time.

When the server device 1 receives the provision information P21 including the date and time information and the provider identification information, in step S220, the server device 1 performs a process of adding an entry of the provider, from which the provision information P21 is transmitted, as a valid provider in the time period indicated by the date and time information included in the provision information P21.

Each of an unspecified number of providers transmits provision information P21 including any date and time information to the server device 1 at any timing. Each time the provision information P21 is transmitted, the server device 1 performs the processing of step S220.

In step S320, the user terminal 21 transmits a use request Q21 to the server device 1. The user who desires to rent the charger 53 performs an operation using the user terminal 21, and inputs predetermined data for a use request. The predetermined data includes, for example, an area where the user desires to rent the charger 53, a rental start date and time, a charging time (time taken to execute charging), a target charging rate or charging power, a current charging rate (state of charge (SOC)), and so on. When the control device 61 of the vehicle 2 serves as the user terminal 21, the control device 61 detects the current charging rate of the in-vehicle battery 62. When the user terminal 21 is a smartphone or the like, the smartphone or the like may communicate with the vehicle 2 to acquire the current charging rate. Alternatively, the current charging rate may be an approximate value, such as “50%” or “30%”, input by the user checking an indication on the display 66 or the like of the vehicle 2.

The target charging rate is an approximate value designated by the user, such as “80%” or “100%”. Alternatively, any value of charging power (W) may be input by the user.

When the use request Q21 including some or all of the items of information such as the desired area, the rental start date and time, the charging time, the target charging rate or charging power, and the current charging rate and the identification information of the user is transmitted from the user terminal 21, in step S221, the server device 1 extracts candidates for the use request Q21.

For example, the server device 1 first accesses the user registration database 7 from the identification information of the user, and acquires the vehicle information such as the vehicle type and the model year of the vehicle 2 of the user. Any information on an available charger is also acquired. The server device 1 also acquires evaluation information regarding the user.

First, the server device 1 extracts providers who satisfy the condition of the area designated in the use request Q21 among providers for whom an entry of provision information has been added. Further, the server device 1 refers to the date and time information of the providers who satisfy the condition of the area, and extracts providers for whom the provision information includes the rental start date and time specified in the use request Q21 and a time slot that can cover the charging time specified in the use request Q21.

The charging time can be calculated by, for example, the server device 1 using the target charging rate in the use request Q21, the current charging rate, and the charging capacity of each of the chargers 53 provided as entries that can be reserved. Accordingly, the server device 1 may extract providers who can rent chargers for the obtained charging time.

Further, the server device 1 excludes, from the extraction target, a provider for whom the charger 53 does not support the vehicle type specified in the use request Q21 or a provider for whom the parking lot 52 does not support the vehicle type specified in the use request Q21 due to the vehicle width, the vehicle height, or the like from among the providers provided as entries that can be reserved.

In addition, a provider for whom the access route to the parking lot 52 is too narrow for a vehicle of the vehicle type specified in the use request Q21 to pass is also excluded from the extraction target.

Through the processes described above, the server device 1 can extract an available rental provider (the parking lot 52 and the charger 53) in response to the use request Q21. In this case, an available rental provider refers to a provider for whom the charger 53 and the parking lot 52 can be used at a desired date and time (over a desired time slot) and the charger 53, the parking lot 52, and the access route support the vehicle 2 of the user.

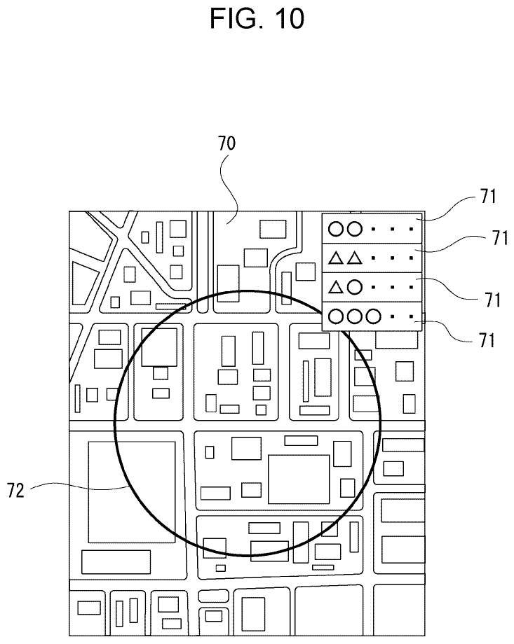

After extracting one or more available rental providers, in step S222, the server device 1 sets a presentation area. For example, when an area where the parking lot 52 of an available rental provider is located is displayed by an area frame 72 on a map as illustrated in FIG. 10, the range of the area frame 72 is set.

In the example illustrated in FIG. 10, for example, in a map image 70, the position of the parking lot 52 of the provider is merely indicated by the area frame 72 in a rough way, and a specific location is not displayed by a pin or the like. This is because the residence 3 or the parking lot 52 of the provider who can be reserved cannot be identified intentionally. That is, since the date and time available for reservation is a date and time when the provider is not at home, the positions of the residence 3 and the parking lot 52 of the provider remain veiled for security.

For this purpose, the server device 1 sets the position and size of the area frame 72, based on the extracted addresses of one or more providers.

For example, when multiple providers are extracted, the position and size of the area frame 72 are set within a range that includes the addresses of all of the providers. It is desirable to set the area frame 72 so that the area frame 72 extends to cover a wider range, rather than the minimum range that actually includes the addresses of the providers.

In a case where a single provider is extracted, the server device 1 sets the position and size of the area frame 72 so that the area frame 72 is not centered on the address of the provider (that is, the address cannot be estimated from the area frame 72).

The shape of the area frame 72 is not limited to a circle, and may be a square or an irregular shape. Alternatively, a frame of an area defined by an administrative division, such as a city area, a town area, or a village area, may be set.

It is to be noted that the user is allowed to check an area including the addresses of the providers, but the precise addresses of the providers are kept unknown to the user.

Then, in step S223, the server device 1 transmits area information including the setting of the area frame 72 and information on candidate providers to the user terminal 21, so that the user terminal 21 can perform the display as illustrated in FIG. 10.

In the example illustrated in FIG. 10, a space for pieces of provider information 71 of the respective providers who can rent the chargers 53 is provided to present necessary information. The server device 1 also transmits information on the candidate providers to the user terminal 21 to display the pieces of provider information 71.

In each of the pieces of provider information 71, information related to a corresponding one of the providers is displayed. Alternatively, in response to an operation on each of the pieces of provider information 71, a detailed information screen of a corresponding one of the providers may be opened to display more detailed information. The display contents in the cases described above may be as follows:
evaluation information of each provider;
the model name, charging capacity, predicted charging time, etc. of the charger 53 of each provider;
the type of the parking lot 52 of each provider (paved, gravel, roofed, etc.);
an image of the charger 53;
an image of the parking lot 52; and
road conditions (such as the road width and the presence or absence of pavement) of an access route to the parking lot 52.

For example, the pieces of information described above are presented to provide the user with information to be used to make a selection while keeping the personal information of each candidate provider hidden.

In one example, the image of the parking lot 52 is useful to indicate the state of the parking lot as the charging spot.

The image of the charger 53 is useful to clarify the type of the charger.

The shape of the gun 54 or an image of the connector 67 may be presented to determine the type of the charger 53. It is also preferable to present an image of a conversion cable, if any.

In the presentation of an image, it is desirable to perform mosaic processing or the like to make any non-target object unrecognizable, thereby ensuring the security of the provider while allowing the user to refer to the image to select the charging spot.

When the server device 1 sets a presentation area in step S222, it is desirable to reflect the evaluation information of the user who has transmitted the use request Q21.

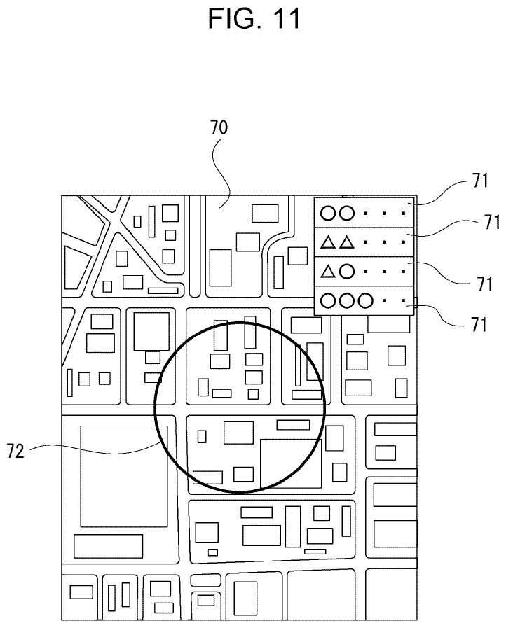

For example, whereas the area frame 72 is usually displayed as illustrated in FIG. 10, the area frame 72 is displayed in a smaller size as illustrated in FIG. 11 to a user having a high evaluation. For example, the position and size of the area frame 72 are set to a minimum range including the addresses of multiple candidate providers. Accordingly, a user having a high evaluation can select a provider within a more clear range.

In addition, the contents displayed in the pieces of provider information 71 may be made more detailed according to the evaluation of the user. For example, the images of the chargers 53 and the parking lots 52 are not displayed to normal users, but may be displayed to a user having a high evaluation.

In step S321, the user terminal 21 displays the screen as illustrated in FIG. 10 or 11 to the user, and performs processing corresponding to the user's operation. For example, the user terminal 21 performs a process of displaying the detailed information of the providers in response to an operation of the user or a process of receiving a decision operation of deciding on a provider.

Although not illustrated, the user may perform an operation of changing the area or the date and time and making a use request again. In this case, the process returns to step S320. In addition, the user may perform an operation of canceling the use request. In this case, the user terminal 21 notifies the server device 1 of cancellation of the use request.

When the user performs the operation of deciding on a provider, in step S322, decision operation information Q22 is transmitted from the provider terminal 51 to the server device 1.

In response to this, the server device 1 performs a reservation setting process in step S224. That is, for the current user, a provider is determined in accordance with the decision operation information Q22, and reservation setting information specifying the date and time and the like is generated.

In step S225, the server device 1 transmits reservation determination notifications R22 and R23 to the provider terminal 51 and the user terminal 21.

The reservation determination notification R22 includes information related to the reservation date and time and the user. Based on this, in step S121, the provider terminal 51 presents information on the determined reservation. For example, the provider terminal 51 presents a user name, date and time information including a charging start date and time and a charging end date and time, vehicle information, and the like to the provider. Further, the provider terminal 51 stores the above-described pieces of information related to the reservation.

The reservation determination notification R23 includes the reservation date and time, position information of the parking lot 52 of the provider, information on the access route, and information related to the charger 53. Based on this, in step S323, the user terminal 21 presents information on the determined reservation. For example, the user terminal 21 presents position information and access information of the parking lot 52, date and time information including a charging start date and time and a charging end date and time, information related to the parking lot 52, and the like to the user. Accordingly, the user can identify the position of the parking lot 52 of the provider.

The user terminal 21 may automatically set the position information of the parking lot 52 of the provider as the destination in a navigation system or an automatic driving control system.

Next, processing related to (ST5) to (ST11) described above, that is, processing after the vehicle 2 of the user arrives at the reserved parking lot 52, will be described with reference to FIG. 12. This processing is performed by the functions of the charging/payment manager 1c of the server device 1, the charging execution processor 21c of the user terminal 21, and the charging manager 51c of the provider terminal 51.

The vehicle 2 of the user who has made the reservation in the process illustrated in FIG. 9 enters the parking lot 52 of the provider on the reserved date and time.

At this time, an authentication process is performed. The authentication process may be performed by the provider terminal 51 as step S130, may be performed by the user terminal 21 as step S330, or may be performed by both the provider terminal 51 and the user terminal 21.

In a case where the authentication process is performed by the provider terminal 51, for example, the provider terminal 51 captures an image of the vehicle 2 entering the parking lot 52 with the camera 59 and analyzes the vehicle number, the vehicle type, the vehicle body color, and the like of the vehicle 2 from the captured image. If the analyzed results match the vehicle number, the vehicle type, the vehicle body color, and the like notified by the reservation determination notification R22, the authentication is successful.

The authentication result is transmitted from the provider terminal 51 to the server device 1 in step S131.

Alternatively, for example, the reservation determination notifications R22 and R23 described above may include information such as a reservation code, and the provider terminal 51 may determine that the authentication is successful if the user inputs a correct reservation code by operating the panel 55 of the charger 53.

As in the example described above, in a case where the authentication process is performed by the provider terminal 51, the authentication result is transmitted from the provider terminal 51 to the server device 1 in step S131.

In a case where the authentication process is performed by the user terminal 21, for example, the user may use the user terminal 21 to read a two-dimensional code or the like displayed on the charger 53 and transmit the read two-dimensional code to the server device 1. In this case, authentication establishment determination is performed by the server device 1. If the authentication is successful, the server device 1 transmits a notification of the successful authentication to the user terminal 21 and the provider terminal 51. In this case, for example, the user terminal 21 reads the two-dimensional code in step S330, and communicates with the server device 1 in step S331 to receive the result of whether the authentication is successful.

In another method, the provider terminal 51 and the user terminal 21 may communicate with each other by wireless communication such as near field communication (NFC) to perform authentication. For example, each of the reservation determination notifications R22 and R23 includes an authentication code or the like of the other terminal. Then, the provider terminal 51 and the user terminal 21 mutually check the authentication codes by wireless communication to perform authentication.

In response to successful authentication by these authentication processes, in step S230, the server device 1 starts charging start management. That is, the server device 1 confirms that the user has arrived at the parking lot 52 of the provider and is ready to start charging.

In the parking lot 52, the user can start charging by attaching the gun 54 of the charger 53 to the connector 67 of the vehicle 2.

If the authentication is not successful, the provider terminal 51 may control the charger 53 not to supply the charging current even when the gun 54 is coupled to the connector 67. Alternatively, a storage of the gun 54 may have a lid with a locking mechanism and remain locked unless the authentication is successful.

During charging, the provider terminal 51 performs a charging process in step S132. For example, the provider terminal 51 measures the amount of charge. For example, the provider terminal 51 monitors and stores a value of a wattmeter attached to the charger 53.

The user terminal 21 performs a charging process in step S332. For example, the user terminal 21 waits for the user to perform an operation of terminating the charging while counting the charging time or the like. In addition, the user terminal 21 may sequentially communicate with the server device 1 to transmit a status during charging.

When the charging ends, the user performs the operation of terminating the charging on the user terminal 21. For example, the user terminal 21 has on a screen thereof a button or the like to be operated at the end of charging.

When the user performs an input operation on the user terminal 21 at the end of charging, in step S333, the user terminal 21 transmits a termination notification Q32 to the server device 1.

The provider terminal 51 determines the end of charging by confirming disconnection, storage, or the like of the gun 54 of the charger 53. In this case, in step S133, the provider terminal 51 transmits a termination notification P32 to the server device 1. The termination notification P32 includes information on the amount of charge.

When the server device 1 receives the termination notifications P32 and Q32, in step S231, the server device 1 confirms that the charging of the currently rented charger 53 ends, and manages history information or the like of the current rent of the charger 53. For example, the server device 1 manages, as history information, the identification information of the user, the identification information of the provider, information on the charging start and end dates and times, the amount of charge, and the like.

Thereafter, the server device 1 performs a payment process in step S240, and the user terminal 21 performs a payment process in step S340. For example, the server device 1 determines a fee corresponding to the current amount of charge, and generates payment data based on a payment method corresponding to the payment information registered for the user. Then, the server device 1 transmits a payment notification R33 based on the payment data to the user terminal 21.

The user terminal 21 performs a display process based on the payment notification R33, and presents the fee for the current charging or the like to the user.

Further, the server device 1 performs a payment process in step S250, and the provider terminal 51 performs a payment process in step S140. For example, the server device 1 determines a fee to be returned to the provider in accordance with the current amount of charge, and generates payment data for receiving money in, for example, a bank account of the provider. Then, the server device 1 transmits a payment notification R34 based on the payment data to the provider terminal 51.

The provider terminal 51 performs a display process based on the payment notification R34, and displays the amount of money to be transferred according to the current charging, the transfer date and time, and the like to the provider.

Thereafter, the user and the provider can transmit the evaluation information at any time.

For example, in step S350, the user terminal 21 transmits evaluation information Q33 of the provider to the server device 1 in response to the operation of the user.

Examples of the evaluation information of the provider may include the state of the parking lot 52, the surrounding environment of the parking lot 52, the state of the access route, and the state of the charger 53.

The user may transmit the evaluation information of the provider to the server device 1, for example, during charging.

In step S260, the server device 1 performs evaluation registration or update process on the evaluation information Q33 transmitted from the user terminal 21. That is, the server device 1 performs processing, such as new registration of evaluation information or registration, addition, or update of evaluation information, on the provider registration database 6 for the target provider of the received evaluation information Q33.

In step S150, the provider terminal 51 transmits evaluation information R35 of the user to the server device 1 in response to the operation of the provider.

Examples of the evaluation information of the user include evaluation information provided by the provider who has returned after the user left, and includes an evaluation of the state of the parking lot 52, the handling of the charger 53, and the like.

In step S261, the server device 1 performs evaluation registration or update process on the evaluation information R35 transmitted from the provider terminal 51. That is, the server device 1 performs processing, such as new registration of evaluation information or registration, addition, or update of evaluation information, on the user registration database 7 for the target user of the received evaluation information R35.

Such evaluation information of the provider and the user is then presented when the user selects a provider, or information for selecting a provider is displayed in a different manner according to the use or the evaluation of the user.

### Effects of Embodiment

According to the embodiment described above, the following effects can be obtained.

The server device 1 according to the embodiment performs a registration process (see FIG. 8) to register information related to one or more providers who provide a charger 53 installed in a parking lot 52 for self-use and information related to one or more users who are to use a charger 53 installed in a parking lot 52 for use by another person.

Further, the server device 1 performs a reservation setting process (see FIG. 9) to, in response to a use request Q21 transmitted from a certain user terminal 21, extract a provider who matches the use request Q21 from the registered information related to the one or more providers, cause the user terminal 21 to present information related to the extracted provider, and set a reservation in accordance with reservation determination information from the user terminal 21.

In addition, the server device 1 performs a payment process (see FIG. 12) to make a payment for using the charger 53 of the provider to charge the vehicle 2 by the user in accordance with the set reservation.

The server device 1 performs the processes as described above, and the charger rental service is executed, thereby setting a general household as a charging spot. As a result, a shortage of charging spots for electric vehicles can be addressed. In addition, the provider can easily implement a business for allowing others to use the charger 53. Accordingly, a system for matching the interests of the user and the provider is achieved.

In particular, the server device 1 performs matching between provision information of the provider, for example, the date and time when the provider can provide the charger 53, and the area and the date and time where and when the user desires to use the charger 53, thereby eliminating the risk of inconvenience to the provider.

In addition, when the server device 1 causes the user terminal 21 to present information related to the provider who matches the use request Q21, the server device 1 causes the user terminal 21 to present the information in such a manner that the home of the provider cannot be identified (see FIG. 9, FIG. 10, and FIG. 11).

The home of the provider cannot be identified when the user selects the provider, thereby hiding information on the residence where the provider is absent in the corresponding time slot. Thus, the security of the provider is secured.

Further, the server device 1 performs a process (step S261 in FIG. 12) of, in response to receipt of the evaluation information related to the user from the provider terminal 51, updating the evaluation information registered for the user, and a process (steps S222 and S223 in FIG. 9) of, when causing the user terminal 21 to present the information related to the provider who matches the use request Q21, presenting the information in a different manner according to the evaluation information of the user.

The information is displayed in a different manner according to the evaluation such that, for example, whereas the display as illustrated in FIG. 10 is provided to normal users, the display as illustrated in FIG. 11 is provided to a user having a high evaluation. Accordingly, for example, a user having a higher evaluation can view more detailed information to select a provider. For example, narrowing down the area frame 72 facilitates selection of a desired place. Further, since the contents to be browsed are changed according to the evaluation, it is possible to promote the improvement of the manner of use by the user.

For example, depending on the evaluation information, whether to present an image may be determined, or the level of detail of the information on the charger 53 may be changed in addition to the size of the area frame 72.

Further, the server device 1 performs a process (step S220 in FIG. 9) of, in response to receipt, from the provider terminal 51, of provision information P21 including the date and time at which the charger 53 is providable from the provider, setting the provider specified in the received provision information P21 as a search target for the use request.

When the provider can rent the charger 53, the provider transmits provision information P21 including date and time information indicating a time slot for which the provider can rent the charger 53 (the available rental start date and time to the available rental end date and time) from the provider terminal 51 to the server device 1. Thus, the provider is set as a search target for a use request made by the user. In other words, the provider merely identifies the date and time at which the provider desires to provide the charger 53, which saves time and effort. As a result, more providers can be expected to provide charging spots.

Further, the server device 1 performs a process (step S260 in FIG. 12) of, in response to receipt of the evaluation information of the provider from the user terminal 21, updating the evaluation information registered for the provider, and a process (step S223 in FIG. 9) of, when causing the user terminal 21 to present the information related to the provider who matches the use request Q21, presenting the evaluation information of the provider together with the information related to the provider.

For example, displaying evaluation information of providers in the pieces of provider information 71 helps the user select a provider.

According to an embodiment of the disclosure, a general household can be set as a charging spot, and a shortage of charging spots for electric vehicles can be addressed. Further, a server device performs matching between a provider and a user in terms of a use area and a date and time, thereby eliminating the risk of inconvenience to the provider.

The server device 1 illustrated in FIG. 5 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the registration processor 1a, the reservation setting processor 1b, and the charging/payment manager 1c. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the modules illustrated in FIG. 5.

1. A server device comprising:
one or more processors; and
a storage medium storing a program to be executed by the one or more processors, wherein
the program comprises one or more instructions, and
the one or more instructions cause the one or more processors to execute:
a registration process to register information related to one or more providers who provide a charger installed in a parking lot for self-use and information related to one or more users who are to use a charger installed in a parking lot for use by another person;
a reservation setting process to, in response to a use request transmitted from a user terminal, extract a provider who matches the use request from registration information, cause the user terminal to present information related to the extracted provider and an area displayed on a map image in such a manner that a home of the provider is not identifiable from the displayed area, and set a reservation in accordance with information from the user terminal; and
a payment process to make a payment for using a charger provided from the provider to charge a vehicle by a user who uses the user terminal in accordance with the set reservation.

2. The server device according to claim 1, wherein the one or more instructions cause the one or more processors to execute:
a process of, in response to receipt of evaluation information related to the user from a provider terminal, updating evaluation information registered for the user; and
a process of, when causing the user terminal to present the information related to the provider who matches the use request, presenting the information in a different manner according to evaluation information of the user.

3. The server device according to claim 1, wherein
the one or more instructions cause the one or more processors to execute:
a process of, in response to receipt, from a provider terminal, of provision information including a date and time at which a charger is providable from a provider, setting the provider as a search target for the use request.

4. The server device according to claim 2, wherein
the one or more instructions cause the one or more processors to execute:
a process of, in response to receipt, from a provider terminal, of provision information including a date and time at which a charger is providable from a provider, setting the provider as a search target for the use request.

5. The server device according to claim 1, wherein
the one or more instructions cause the one or more processors to execute:
a process of, in response to receipt of evaluation information related to the provider from the user terminal, updating evaluation information registered for the provider; and
a process of, when causing the user terminal to present the information related to the provider who matches the use request, presenting evaluation information of the provider together with the information related to the provider.

6. The server device according to claim 2, wherein
the one or more instructions cause the one or more processors to execute:
a process of, in response to receipt of evaluation information related to the provider from the user terminal, updating evaluation information registered for the provider; and
a process of, when causing the user terminal to present the information related to the provider who matches the use request, presenting evaluation information of the provider together with the information related to the provider.
